(19) United States
(12) Patent Application Publication
(10) Pub. No.: US 2007/0036138 A1
(43) Pub. Date: Feb. 15, 2007

(54) VoIP communication module

(76) Inventors: Chia-Ching Lin, Hsinchu (TW); Wei-Lun Wan, Hsinchu (TW)

Correspondence Address: HARNESS, DICKEY & PIERCE, P.L.C., P.O. BOX 8910, RESTON, VA, 20195, US

(21) Appl. No.: 11/195,690

(22) Filed: Aug. 3, 2005

(51) Int. Cl. H04L 12/66

(52) U.S. Cl. 370/352

(57) ABSTRACT

A VoIP (Voice over Internet Protocol) communication module is provided for establishing a communication connection over a network, including a network connection module, a command translator, and a processing module, wherein the command translator receives and translates AT commands from external application programs or modules, thereby providing services such as communication over an IP network.

### BACKGROUND

1. Field of Invention

The invention relates to a VoIP (Voice over Internet Protocol) communication module and, more particularly, to a VoIP communication module that enables a terminal device to use an AT command set as a standard control interface.

2. Related Art

With the increasingly wide use of the Internet and its advantage of low cost for transmitting data, a new technology, i.e. Voice over Internet Protocol (VoIP), has been developed, which uses the Internet as the transport for voice information.

Instead of relying on the traditional Public Services Telephone Network (PSTN) to transmit voice data, VoIP digitalizes, compresses, and translates consecutive voice signals into IP packets for transmission over an IP network based on Internet Protocol. Furthermore, with the expansion of bandwidth and the advancement of related technology, the VoIP technology has become useful for an increasingly wider range of applications, and various kinds of electronic devices supporting VoIP have also been developed, such as VoIP phones, VoIP Gateways, VoIP switches and Wi-Fi phones, etc.

These supporting devices for VoIP incorporate a VoIP module to provide all kinds of VoIP functions. The VoIP module may include: a first processor, e.g., a Reduced Instruction Set Computing (RISC) processor, for executing the communication control protocol, such as H.323, Session Initiation Protocol (SIP), Media Gateway Control Protocol (MGCP), Media Gateway Control Protocol (Megaco) and the like, Internet Protocol (IP), e.g., Transmission Control Protocol (TCP), User Datagram Protocol (UDP), Internet Protocol (IP), Internet Control Message Protocol (ICMP), Secure Socket Layer (SSL), Secure Shell (SSH) protocol, hypertext transmission protocol (HTTP), Address Resolution Protocol (ARP) and the like, and other functions related to the communication; and a second processor, e.g., a digital signal processor (DSP) for performing functions related to the compression an decompression of voice signals. The wireless VoIP communication device, such as Wi-Fi Phone) further has a wireless communication module to provide wireless communication functions.

The VoIP module and the VoWLAN (Voice over Wireless Local Area Network) module are highly promising technologies at present. The VoWLAN module is a newly-developed technology that combines the popular WLAN and VoIP technologies to realize the VoIP communication in the WLAN environment. However, each manufacturer in the industry provides a control interface specific to the VoIP module that it has designed, which hinders the development of VoIP-related products by other manufacturers in the industry. In other words, if a manufacturer of VoIP-related products adopts a VoIP module designed by a specific developer, then the manufacturer has to use the control interface designed by the same developer to develop new VoIP-related products. For example, when a manufacturer adopts VoIP modules produced by different developers out of consideration of risk or other factors, they will not be able to benefit from their prior experience in developing similar products and expedite the development of new products. Therefore if a control interface compatible with the VoIP modules produced by different developers becomes available, then the manufacturers of VoIP-related products will have greater flexibility in product design and VoIP module selection.

### SUMMARY

Accordingly, the present invention is directed to a VoIP communication module, thereby substantially solve the problems in the prior art.

The disclosed VoIP communication module that enables a terminal device to use an AT command set as the standard control interface.

The disclosed VoIP communication module is utilized for easily changing required VoIP or VoWLAN modules, where the change is not limited by the upper interface.

The disclosed VoIP communication module is utilized to reduce the complexity of new product development and therefore improve the efficiency for developing new products.

To achieve these and other advantages and in accordance with the purpose of the present invention, as embodied and broadly described, the VoIP communication module includes: a network connection module, a command translator, and a processing module. The network connection module connects to a network. The command translator receives AT commands from external application programs or modules and translates the AT commands into corresponding control signals. The processing module connecting the network connection module and the command translator transmits the control signals to an external network through the network connection module, thereby establishing the communication connection.

The processing module includes: a first processor to execute the communication control protocol, internet protocol, and other functions with relation to the communication; and a second processor to compress or decompress voice signals transmitted through the network, thereby lowering the demand for bandwidth. The first processor may be a general-purpose processor (GPP). The second processor may be a digital signal processor.

Moreover, the processing module may be a single general-purpose processor to process all the functions of the processing module.

The command translator of the invention receives external AT commands through a connection interface. The connection interface may be a standard serial interface, such as: RS-232 interface, or Universal Serial Bus (USB).

The AT commands is defined by a Global System for Mobile Communication (GSM) standard for controlling a mobile communication module or defined by an International Telecommunication Union-Telecommunication Standardization Sector (ITU-T) recommendation standard. Furthermore, the AT commands may be compatible with the extended standards of these two types of standards.

As described above, when applying an exemplary embodiment of the invention to a terminal device, an AT command set can be used as the standard control interface, whereby various communication functions such as making IP network phone calls and sending messages and faxes can be realized. Furthermore, when developing a new product, manufacturers may adopt different VoIP modules according to the invention in light of market demand without having to change the upper interface, thereby simplifying the development of new products and increasing the efficiency of new product development.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow illustration only and thus does not limit the present invention, wherein:

FIG. 1 depicts a VoIP communication module according to an exemplary embodiment of the invention; and

FIG. 2 depicts a VoIP communication module according to another exemplary embodiment of the invention.

### DETAILED DESCRIPTION OF THE INVENTION

The main idea of the invention is to apply an AT command set (attention command set) to an VoIP module or an VoWLAN module, which receives the AT commands and then carries out functions such as VoIP dialing, setting network services, and setting VoIP or VoWLAN modules.

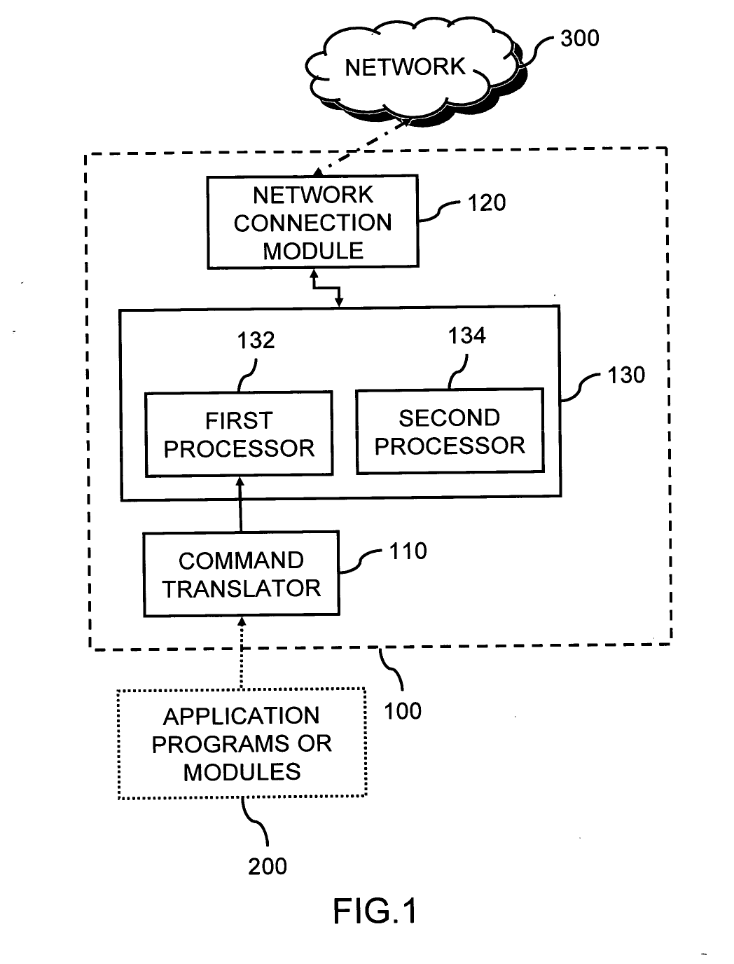

FIG. 1 depicts a VoIP communication module according to an exemplary embodiment of the invention. As shown in FIG. 1, the VoIP communication module 100 includes a command translator 110, a network connection module 120, and a processing module 130.

The command translator 110 may be connected to an external application program or module 200 to receive AT commands from the application program or module 200, and translate the AT commands into control signals. The AT commands may be existing AT commands, such as commands defined by International Telecommunication Union—Telecommunication Standardization Sector (ITU-T) recommendation-V.25ter, or AT commands applied to mobile communication modules used in Global System for Mobile Communication (GSM) (e.g., commands defined by GSM07.07 standards). The AT commands may be compatible with extended standards of the above two types of standards.

The network connection module 120 provides network connection functions and transmits packets through the network 300. The network connection module 120 may be a network module (e.g., Ethernet module) or a wireless transceiver module, e.g., a radio frequency (RF) transceiver module, a bluetooth module, WLAN transceiver module, or wireless transceiver module complying with 802.11x standards established by the Institute of Electrical and Electronics Engineers (IEEE) (e.g., Standard 802.11a, 802.11b, 802.11g, 802.11h, 802.11i, or standards covering at least two 802.11x series standards).

The processing module 130 is connected to the command translator 110 and the network connection module 120. The processing module 130 receives control signals from the command translator 110 and transmits the control signals to the network 300 through the network connection module 120, thereby setting up communication through the network 300.

The processing module 130 includes a first processor 132 and a second processor 134.

The first processor 132 executes the communication control protocol, such as H.323, Session Initiation Protocol (SIP), Media Gateway Control Protocol (MGCP), Media Gateway Control Protocol (Megaco) and the like, Internet Protocol (IP), e.g., Transmission Control Protocol (TCP), User Datagram Protocol (UDP), Internet Protocol (IP), Internet Control Message Protocol (ICMP), Secure Socket Layer (SSL), Secure Shell (SSH) protocol, hypertext transmission protocol (HTTP), Address Resolution Protocol (ARP) and the like, and other functions related to the communication. The first processor 132 may be a general-purpose processor. The communication control protocol, such as H.323, Session Initiation Protocol (SIP), Media Gateway Control Protocol (MGCP), Media Gateway Control Protocol (Megaco) and the like, serves as the standards for controlling the functions related to the communication establishment.

The second processor 134 performs the function of compressing/decompressing voice signals to thereby lessen the demand for bandwidth when transmitting the signals through the network 300. The second processor 134 may be a digital signal processor (DSP).

The second processor 134 may also be a software emulation of the first processor 132. That is, the second processor 130 may be a single general-purpose processor.

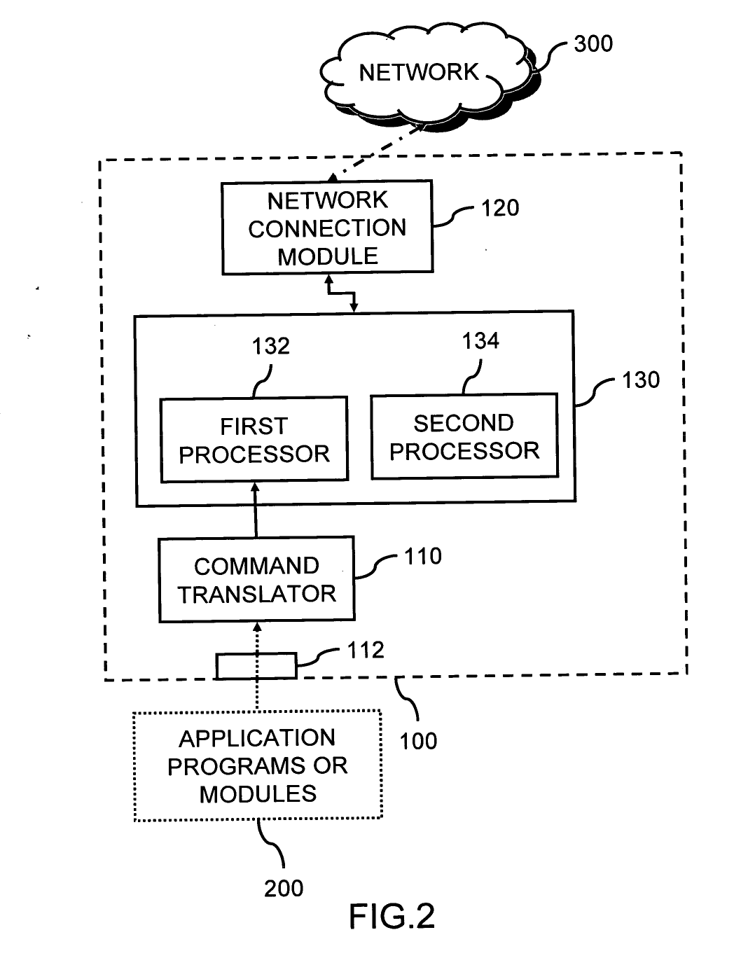

The command translator 110 may receive external AT commands through a connection interface 112, as shown in FIG. 2. The connection interface 112 may be a standard serial interface such as an RS-232 interface or a Universal Serial Bus (USB).

As an example, we assume the connection module in a VoIP communication module according to an exemplary embodiment of the invention is a WLAN module (in this case the VoIP communication module is a VoWLAN module) and the connection interface is an RS-232 interface. When making a VoIP phone call, a command “ATD+1 812 555673; OK” (which means dialing the telephone number +1812555673) from an application program or module connected to VoWLAN is transmitted through the RS-232 interface. When the AT command translator receives the command, it translates the command according to a pre-specified communication protocol; in other words, assuming SIP is the pre-specified communication protocol, the command will be translated into SIP signals as follows:

INVITE sip:+1812555673@zcom.com SIP/2.0

Via: SIP/2.0/UDP pc33.zcom.com; branch=z9hG4bK776asdhds

Max-Forwards: 70

To: Bob <sip:+1812555673@zcom.com>

From: Alice <sip:+1812555666@zcom.com>; tag=1928301774

Call-ID: a84b4c76e66710@pc21.zcom.com

CSeq: 314159 INVITE

Contact: <sip:+1812555666@pc21.atlanta.com>

Content-Type: application/sdp

Content-Length: 142

Then, the SIP signals will be sent out to the recipient through the WLAN module. After the exchanges of signals are completed, the phone conversation can start.

To put it simply, if an exemplary embodiment of the invention is applied to a mobile communication device, i.e., if a VoIP communication module according to an exemplary embodiment of the invention is used to replace the GSM mobile communication module, then the mobile communication device can use a control interface similar to that used for the GSM mobile communication module. That is, the mobile communication device can use an AT command set complying with the extended standards of the GSM standards as the standard control interface for the VoIP communication module, thereby realizing communication functions such as making IP network phone calls and sending messages and faxes. Thus, when manufacturers develop new VoIP-related products, they can select different types of VoIP modules based on market demand without having to substantially alter the upper interface to match the specific VoIP module, which simplifies the process for developing new products and improves the efficiency of product development. The intervention can also be applied to other types of terminal devices to provide the above-mentioned functions.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A VoIP communication module for establishing a communication connection over a network, comprising:
a network connection module for connecting the network;
a command translator for receiving an AT command and translating the AT command into a corresponding control signal; and
a processing module connecting the network connection module and the command translator for transmitting the control signal to the network through the network connection module, thereby establishing the communication connection.

2. The VoIP communication module of claim 1, wherein the processing module includes:
a first processor for executing communication control protocol, internet protocol, and functions with relation to the communication; and
a second processor for selectively compressing and decompressing a voice signal transmitted over the network.

3. The VoIP communication module of claim 2, wherein the first processor is a general-purpose processor.

4. The VoIP communication module of claim 2, wherein the second processor is a digital signal processor.

5. The VoIP communication module of claim 1, wherein the processing module is a general-purpose processor.

6. The VoIP communication module of claim 1, wherein the AT command is selected from the group consisting of an AT command for controlling a mobile communication module, an existing AT command, and a compatible AT command.

7. The VoIP communication module of claim 6, wherein the AT command for controlling the mobile communication module complies with a Global System for Mobile Communication (GSM) standard.

8. The VoIP communication module of claim 6, wherein the existing AT command complies with an International Telecommunication Union-Telecommunication Standardization Sector (ITU-T) recommendation standard.

9. The VoIP communication module of claim 6, wherein the compatible AT command complies with extended standards of the GSM standard and the ITU-T recommendation standard.

10. The VoIP communication module of claim 1, wherein the network connection module is a network module.

11. The VoIP communication module of claim 10, wherein the network module is an Ethernet.

12. The VoIP communication module of claim 1, wherein the network connection module is a wireless transceiver module.

13. The VoIP communication module of claim 12, wherein the wireless transceiver module is selected from the group consisting of a radio frequency (RF) transceiver module, a bluetooth module, a WLAN transceiver module, or a wireless transceiver module according to an institute of electrical and electronics engineers (IEEE) 802.11x standard.

14. The VoIP communication module of claim 1, further comprising:
a connection interface connected to the command translator;
wherein the command translator receives the AT command through the connection interface from outside.
